(19) United States
(12) Patent Application Publication
(10) Pub. No.: US 2007/0109564 A1
(43) Pub. Date: May 17, 2007

(54) Apparatus and method for reproducing original colors in an image forming apparatus

(75) Inventor: Naomi Nakane, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/271,742

(22) Filed: Nov. 14, 2005

(51) Int. Cl. H04N 1/60

(52) U.S. Cl. 358/1.9; 358/518

(57) ABSTRACT

An apparatus and method for reproducing a color copy of an original color image includes receiving an indication of a selected color having a first RGB value from a plurality of colors, generating a color sample pattern including the selected color having the first RGB value, the color sample pattern including colors with RGB values adjacent to the first RGB value, and receiving an indication of another selected color having a second RGB value corresponding to a color selected from the color sample pattern. An original image is scanned, the scanned original image comprising a plurality of pixels, each pixel having a corresponding RGB value. Identified pixels of the scanned original image whose RGB value matches the first RGB value are converted to the second RGB value. The original image is reproduced based on the scanned original image and the converted pixels.

### FIELD OF THE INVENTION

The present invention relates generally to image forming apparatuses and, more particularly, to a system and method for reproducing original colors in an image forming apparatus.

### BACKGROUND OF THE INVENTION

To make a color copy on a copier or multi-function-peripheral, an original image is scanned by a light from a lamp, and the light reflected from the scanned image is detected by a charge-coupled device (CCD). The CCD converts the detected light into red, green, and blue (RGB) image data. The RGB image data, in addition to undergoing other image processing algorithms, is converted to cyan, magenta, yellow, and black (CMYK) image data. The image data must be converted from RGB data to CMYK data before printing.

In a conventional color copier, the conversion from RGB data to CMYK data is performed with a color conversion table. For each pixel of the RGB data, there is typically eight bits used to represent the density of each color, i.e. between 0 and 255. Since there are three colors with eight bits each, the RGB color space is 256×256×256 or approximately 16 megabytes. To avoid using such a large color space, a smaller color space for the RGB data, such as 9×9×9 or 729 bytes, is used. This lower resolution significantly limits the color variation that can be reproduced by the color copier.

Furthermore, even when the eight bit resolution is used, the reproduction of a particular color typically results in at least a small variation from the color of the original image. In particular, for a particular color, the scanner determines the applicable RGB value, which is converted to CMYK, and the particular color is reproduced with a mix of cyan, magenta, yellow, and black inks according to the CMYK value. The original color, however, may be based on more than four inks, which results in the variation between the original color and the corresponding reproduced color.

Due to the limits of the color variation and the limited number of inks used to reproduce an original color, the color copier may not be able to reproduce a specific color desired by a user, such as for a corporate logo or advertisement. It would therefore be desirable to have a color copier that can accurately reproduce a specific color desired by the user. Further, it would be desirable to achieve this reproduction without the user having to attempt a color balance adjustment several times to attempt to reproduce the original color.

### SUMMARY OF THE INVENTION

According to an aspect of the invention, an image forming apparatus and method for reproducing a color copy of an original color image includes receiving an indication of a selected color having a first RGB value from a plurality of colors, generating a color sample pattern including the selected color having the first RGB value, the color sample pattern including colors with RGB values adjacent to the first RGB value, and receiving an indication of another selected color having a second RGB value corresponding to a color selected from the color sample pattern. An original image is scanned, the scanned original image comprising a plurality of pixels, each pixel having a corresponding RGB value. Identified pixels of the scanned original image whose RGB value matches the first RGB value are converted to the second RGB value. The original image is reproduced based on the scanned original image and the converted pixels.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 shows a block diagram of an image forming apparatus consistent with the present invention.

FIG. 2 shows a block diagram of a control system for the image forming apparatus of FIG. 1.

FIG. 3 is a block diagram of a color adjustment system consistent with the present invention.

FIG. 4 is a graphical representation of a color space used in the color adjustment system of FIG. 3.

FIG. 5 is an example of a color sample pattern used in the color adjustment system of FIG. 3.

FIG. 6 is a flow diagram of a color adjustment process consistent with the present invention.

### DETAILED DESCRIPTION OF PREFERRED EMBODIMENT

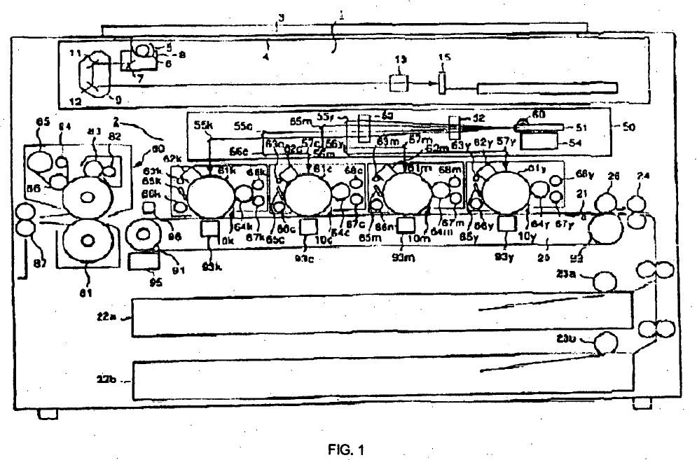

FIG. 1 shows a block diagram of an image forming apparatus consistent with the present invention. The image forming apparatus may be a hardcopy device such as a digital type color copier for forming a copied image of a color image. As shown in FIG. 1, the image forming apparatus includes a color scanner portion 1, which scans and reads a color image on a document and a color printer portion 2, which forms a copied image of the color image.

The color scanner portion 1 includes a document base cover 3 at an upper portion thereof. A document base 4 is arranged opposite to the document base cover 3 in a closed state and includes transparent glass on which the document is set. On a lower side of the document base 4 are arranged an exposure lamp 5 for illuminating the document mounted on the document base 4, a reflector 6 for focusing light from the exposure lamp 5 to the document and a first mirror 7 for reflecting the light from the document. The exposure lamp 5, the reflector 6 and the first mirror 7 are fixed to a first carriage 8. The first carriage 8 is moved by a pulse motor, not illustrated, along a lower face of the document base 4.

A second carriage 9 is arranged in a direction in which the light is reflected by the first mirror 7 and provided movably in parallel with the document base 4 via a drive mechanism, such as a belt with teeth in conjunction with a direct current motor or the like. The second carriage 9 includes a second mirror 11 for reflecting the light from the first mirror 7 to a third mirror 12. The third mirror 12 then reflects the light from the second mirror 11. The second carriage 9 is driven by the first carriage 8 and is moved along the document base 4 in parallel therewith at half the speed of the first carriage 8.

A focusing lens 13 focuses the light reflected from the third mirror 12 by a predetermined magnification. A CCD type color image sensor or photoelectric conversion element 15 converts the reflected light focused by the focusing lens 13 into an electric signal.

When light from the exposure lamp 5 is focused on the document on the document base 4 by the reflector 6, the reflected light from the document is made to be incident on the color image sensor 15 via the first mirror 7, the second mirror 11, the third mirror 12 and the focusing lens 13. At the color image sensor 15, the incident-light is converted into an electric signal in accordance with the three primary colors of light of R (red), G (green) and B (blue).

The color printer portion 2 includes first through fourth image forming portions 10y, 10m, 10c and 10k. These image forming portions form images that are subjected to color decomposition for respective color components. In particular, the images are decomposed into the four colors of yellow (y), magenta (m), cyan (c) and black (k) according to known decomposition methods, such as the subtractive mixing method.

A transfer mechanism 20, which includes a transfer belt 21, transfers the images of the respective colors formed by the respective image forming portions-in-a-direction shown by the arrow marked “a” in FIG. 1. The transfer belt 21 is wound to expand between a drive roller 91 rotated by a motor in the direction shown by the arrow marked “a,” and a drive roller 92 separated from the drive roller 91 by a predetermined distance rotating at a constant speed in the direction of the arrow marked “a.” The image forming portions 10y, 10m, 10c and 10k are arranged in series along a transfer direction of the transfer belt 21.

The image forming portions 10y, 10m, 10c and 10k include photosensitive drums 61y, 61m, 61c and 61k, respectively, as image carriers. Outer peripheral faces of the drums are formed in the same direction at respective positions in contact with the transfer belt 21. The photosensitive drums 61y, 61m, 61c and 61k are rotated at a predetermined speed by a motor.

The photosensitive drums 61y, 61m and 61c and 61k are arranged such that their axis lines are respectively disposed at equal intervals and are arranged such that the axis lines are orthogonal to the direction that the images are transferred by the transfer belt 21. The directions of the axis lines of the photosensitive drums 61y, 61m, 61c and 61k are defined as main scanning directions (second direction). The rotational directions of the photosensitive drums 61y, 61m, 61c and 61k, which correspond to a rotational direction of the transfer belt 21 (the arrow marked “a”), are defined as sub-scanning directions (first direction).

Electricity charging apparatus 62y, 62m, 62c and 62k, electricity removing apparatus 63y, 63m, 63c and 63k and developing rollers 64y, 64m, 64c and 64k are all extended in the main scanning direction. Lower agitating rollers 67y, 67m, 67c and 67k, upper agitating rollers 68y, 68m, 68c and 68k, transcribing apparatus 93y, 93m, 93c and 93k, and cleaning blades 65y, 65m, 65c and 65k also extend in the main scanning direction. Discharged toner recovery screws 66y, 66m, 66c and 66k are arranged successively along the rotational direction of the photosensitive drums 61y, 61m, 61c and 61k.

Transcribing apparatus 93y, 93m, 93c and 93k are arranged at positions sandwiching the transfer belt 21 between them. Corresponding ones of the photosensitive drums 61y, 61m, 61c and 61k are arranged on an inner side of the transfer belt. Further, exposure points by an exposure apparatus 50 are respectively formed on the outer peripheral faces of the photosensitive drums 61y, 61m, 61c and 61k between the electricity charging apparatus 62y, 62m, 62c and 62k and developing rollers 64y, 64m, 64c and 64k.

Sheet cassettes 22a and 22b are arranged on a lower side of the transfer mechanism 20 and contain sheets of the sheet P as image forming media for transcribing images formed by the respective image forming portions 10y, 10m, 10c and 10k. Pickup rollers 23a and 23b are arranged at end portions on one side of the sheet cassettes 22a and 22b and on sides thereof proximate to the drive roller 92. Pickup rollers 23a and 23b pick up the sheet P contained in the sheet cassettes 22a and 22b sheet by sheet from topmost portions of the sheets. A register roller 24 is arranged between the pickup rollers 23a and 23b and the drive roller 92. The register roller 24 matches a front end of the sheet P picked from the sheet cassette 22a or 22b and a front end of a toner image formed at the photosensitive drum 61y of the image forming portion 10y. Toner images formed at the other photosensitive drums 61y, 61m and 61c are supplied to respective transcribing positions in conformity with transfer timings of the sheet P transferred on the transfer belt 21.

An adsorbing roller 26 is arranged between the register roller 24 and the first image forming portion 10y, at a vicinity of the drive roller 92, such as above an outer periphery of the drive roller 92 substantially pinching the transfer belt 21. The adsorbing roller 26 provides electrostatic adsorbing force to the sheet P transferred at predetermined timings via the register roller 24. The axis line of the adsorbing roller 26 and the axis line of the drive roller 92 are set to be in parallel with each other.

A positional shift sensor 96 is arranged at one end of the transfer belt 21, and at a vicinity of the drive roller 91, such as above an outer periphery of the drive roller 91 substantially pinching the transfer belt 21. The positional shift sensor 96 detects a position of the image formed on the transfer belt 21. The positional shift sensor 96 may be implemented, for example, as a transmitting type or a reflecting type optical sensor.

A transfer belt cleaning apparatus 95 is arranged on an outer periphery of the drive roller 91 and above the transfer belt 21 on the downstream side of the positional shift sensor 96. The transfer belt cleaning apparatus 95 removes toner or paper dust off the sheet P adhered onto the transfer belt 21.

A fixing apparatus 80 is arranged to receive the sheet P when it detaches from the transfer belt 21 and transfers the sheet P further. The fixing apparatus 80 fixes the toner image on the sheet P by melting the toner image transcribed onto the sheet P by heating the sheet P to a predetermined temperature. The fixing apparatus 80 includes a pair of heat rollers 81, oil coating rollers 82 and 83, a web winding roller 84, a web roller 85 and a web pressing roller 86. After the toner formed on the sheet P is fixed to the sheet, the sheet P is discharged by a paper discharge roller pair 87.

The exposure apparatus 50 forms electrostatic latent images subjected to color decomposition on the outer peripheral faces of the photosensitive drums 61y, 61m, 61c and 61k. The exposure apparatus is provided with a semiconductor laser oscillator 60 controlled to emit light based on image data (Y, M, C, K) for respective colors subjected to color decomposition by an image processing apparatus 36.

On an optical path of the semiconductor laser oscillator 60, there are successively provided a polygonal mirror 51 rotated by a polygonal motor 54 for reflecting and scanning a laser beam light and fθ lenses 52 and 53 for correcting and focusing a focal point of the laser beam light reflected via the polygonal mirror 51. First folding mirrors 55y, 55m, 55c and 55k are arranged between the fθ lens 53 and the photosensitive drums 61y, 61m, 61c and 61k. The first folding mirrors 55y, 55m, 55c and 55k fold or reflect the laser beam light of respective colors that have passed through the fθ lens 53 toward the exposure positions of the photosensitive drums 61y, 61m, 61c and 61k. Second and third folding mirrors 56y, 56m, 56c and 57y, 57m and 57c further fold or reflect the laser beam light folded by the first folding mirrors 55y, 55m and 55c. The laser beam light for black is folded or reflected by the first folding mirror 55k and thereafter guided onto the photosensitive drum 61k without detouring other mirrors.

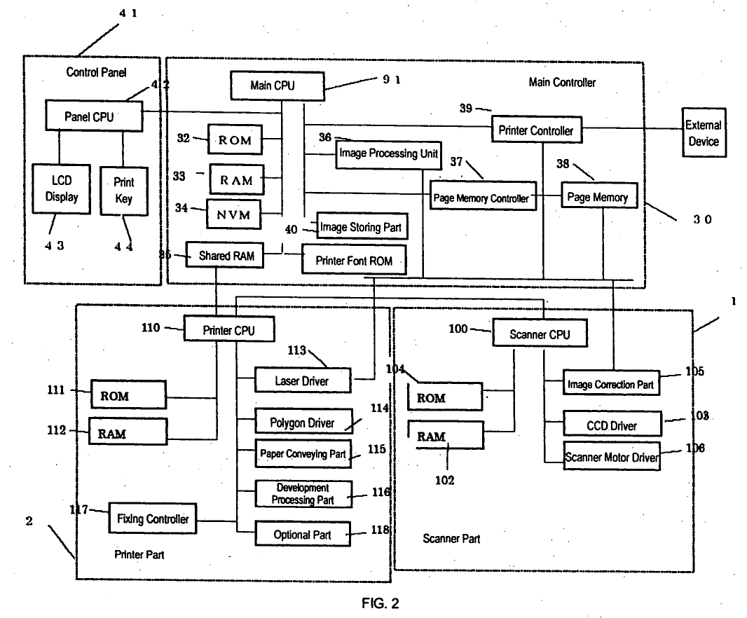

FIG. 2 shows a block diagram of a control system for the image forming apparatus of FIG. 1. In FIG. 2, the control system includes three CPUs: a main CPU (Central Processing Unit) 91 in a main control portion 30; a scanner CPU 100 of the color scanner portion 1; and a printer CPU 110 of the color printer portion 2. The main CPU 91 carries out bidirectional communication with the printer CPU 110 via a common ROM (Random Access Memory) 35. The main CPU 91 issues operation instructions, and the printer CPU 110 returns state statuses. The printer CPU 110 and the scanner CPU 100 carry out serial communication. The printer CPU 110 issues operation instructions, and the scanner CPU 100 returns state statuses.

An operation panel 41 includes a liquid crystal display portion 43, various operation keys 44 and a panel CPU 42. The operation panel 41 is connected to the main CPU 91. The main control portion 30 includes the main CPU 91, a ROM (Read Only Memory) 32, a RAM 33, an NVRAM 34, the common RAM 35, the image processing apparatus 36, a page memory control portion 37, a page memory 38, a printer controller 39 and a printer font ROM 121.

The main CPU 91 controls the main control portion 30. The ROM 32 is stored with control programs. The RAM 33 is for temporarily storing data. The NVRAM (Nonvolatile Random Access Memory: Nonvolatile RAM) 34 is a memory backed up with a battery (not illustrated) for holding stored data even when a power source is cut. The common or shared RAM 35 is for carrying out bidirectional communication between the main CPU 91 and the printer CPU 110.

The page memory control portion 37 stores and reads image information to and from the page memory 38. The page memory 38 includes an area capable of storing a plurality of pages of image information and is formed to be able to store data compressed with image information from the color scanner portion 1 for each compressed page.

The printer font ROM 121 is stored with font data in correspondence with the print data. The printer controller 39 develops printer data from an outside apparatus 122, such as a personal computer, into image data. The printer controller uses the font data stored in the printer font ROM 121 at a resolution in accordance with data indicating a resolution included in the printer data.

The color scanner portion 1 includes the scanner CPU 100, which controls the color scanner portion 1. The color scanner portion also includes a ROM 101 stored with control programs, a RAM 102 for storing data, a CCD driver 103 for driving the color image sensor 15, a scanning motor driver 104 for controlling rotation of a scanning motor and moving the first carriage 8, and an image correcting portion 105. The image correcting portion 105 includes an A/D conversion circuit for converting analog signals of R, G and B outputted from the color image sensor 15 respectively into digital signals, a shading correction circuit for correcting a dispersion in a threshold level with respect to an output signal from the color image sensor 15 caused by a variation in the color image sensor 15 or surrounding temperature change, and a line memory for temporarily storing the digital signals subjected to shading correction from the shading correction circuit.

The color printer portion 2 includes the printer CPU 110, which controls the color printer portion 2. The color printer portion 2 also includes a ROM 111 stored with control programs, a RAM 112 for storing data, the laser driver 113 for driving the semiconductor laser oscillator 60, a polygonal motor driver 114 for driving the polygonal motor 54 of the exposure apparatus 50, and a transfer control portion 115 for controlling the transfer of the sheet P by the transfer mechanism 20.

The color printer portion 2 further includes a process control portion 116, a fixing control portion 117 for controlling the fixing apparatus 80, and an option control portion 118 for controlling options. The process control portion 116 controls processes for charging electricity, developing and transcribing by use of the electricity charging apparatus, the developing roller and the transcribing apparatus. The image processing portion 36, the page memory 38, the printer controller 39, the image correcting portion 105 and the laser driver 113 are connected to each other by an image data bus 120.

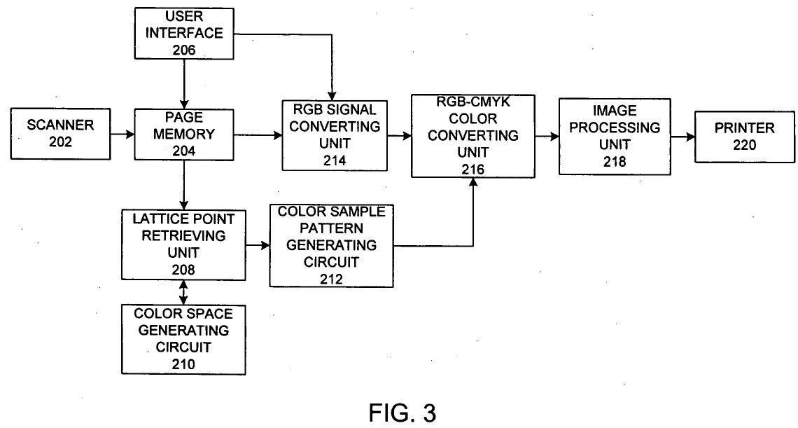

FIG. 3 is a block diagram of a color adjustment system consistent with the present invention. The color adjustment system includes components that are part of the control system of FIG. 2 or can be implemented as additional components of the control system of FIG. 2. In addition, the color adjustment system can be implemented in hardware, in software, or in some combination thereof. As shown in FIG. 3, the color adjustment system includes a scanner 202, a page memory 204, a user interface 206, a lattice point retrieving unit 208, a color space generating circuit 210, a color sample generating circuit 212, an RGB signal converting unit 214, an RGB-CMYK color converting unit 216, an image processing unit 218, and a printer 220.

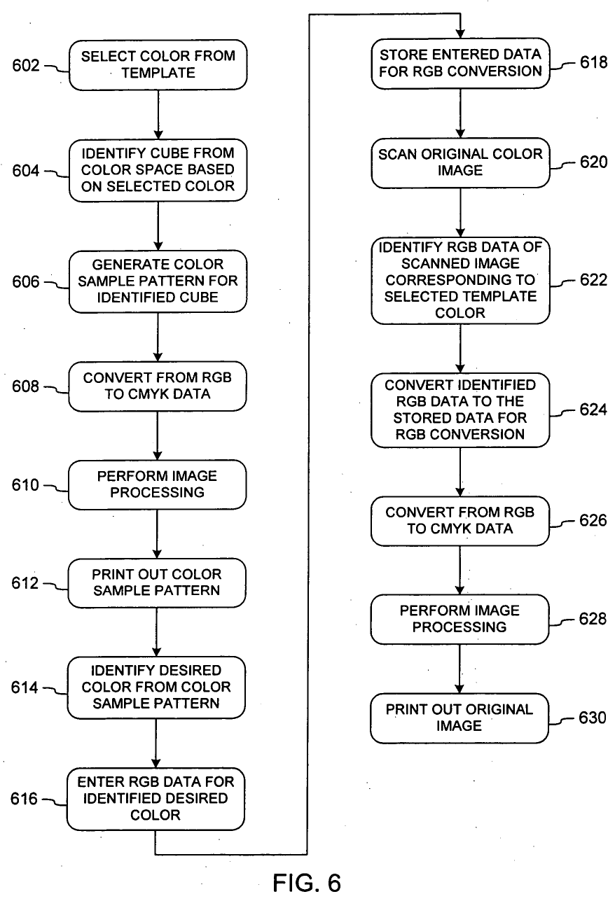

The scanner 202 can be implemented in the same manner as the color scanner portion 1, described above, including the exposure lamp 5, the reflector 6, the mirrors 7, 11, and 12, the carriages 8 and 9, the focusing lens 13, and the CCD or photoelectric conversion element 15. The scanner 202 generates image data from a scanned original image. The image data, which is in an RGB format, is received by and stored in the page memory 204. The page memory 204 can be implemented, for example, as RAM or NVRAM. As described above, with respect to the main control portion 30, the page memory 204 includes an area capable of storing one or more pages of image information and is formed to be able to store data compressed with image information from the scanner 202 for each compressed page. The user interface 206 can be implemented in the same manner as the operation panel 41, described above, including the liquid crystal display portion 43 and various operation keys 44. The user interface 206 enables the user to select settings for a copy job or other function being performed on the image forming apparatus, as well as to enter information to be used in the color selection process described herein below with respect to FIG. 6.

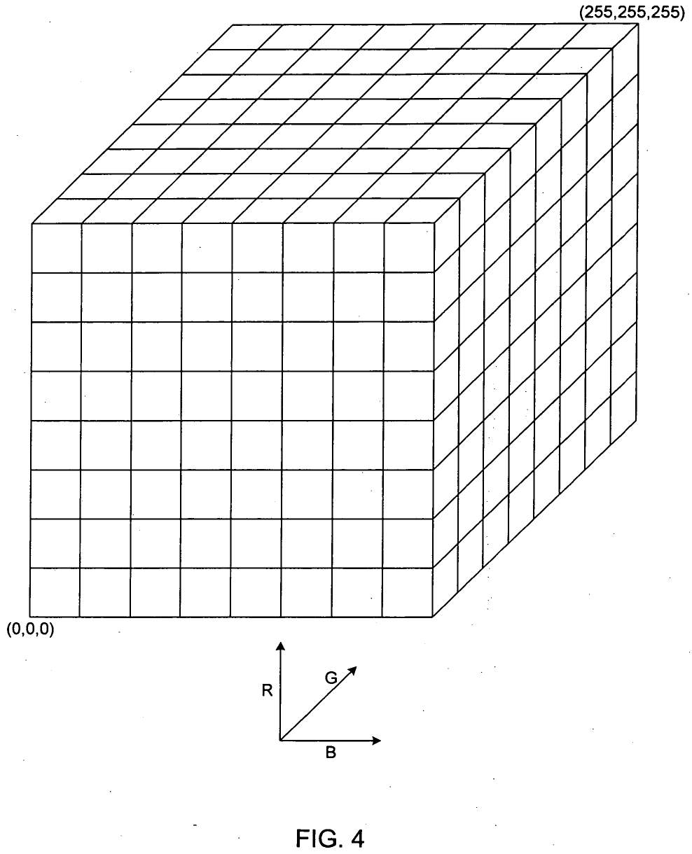

The color space generating circuit 210 generates a color space used for color adjustment. FIG. 4 is a graphical representation of a color space used that can be generated by the color space generating circuit 210. As shown in FIG. 4, the color space has a cubic shape. The y-axis represents red R, the x-axis represents blue B, and the z-axis represents green G. Further, each axis represent a value between 0 and 255, such that the overall color space represent RGB values between (0,0,0) and (255,255,255). Each axis is divided into eight sections, such that the overall cube of the color space is made up of 8×8×8 sub-cubes (i.e., 512 sub-cubes). Each sub-cube therefore represents a span of 32×32×32 RGB values. For example, the sub-cube with the axis at (0,0,0) represent RGB values between (0,0,0) and (31,31,31).

The lattice point retrieving unit 208 selects a particular sub-cube from the color space generated by the color space generating circuit 210. The lattice point retrieving unit 208 selects the sub-cube based on a RGB value that is inputted or designated through the user interface 206. For example, if the designated RGB value is (40,48,52), then the sub-cube chosen is the one representing RGB values between (32,32,32) and (64,64,64).

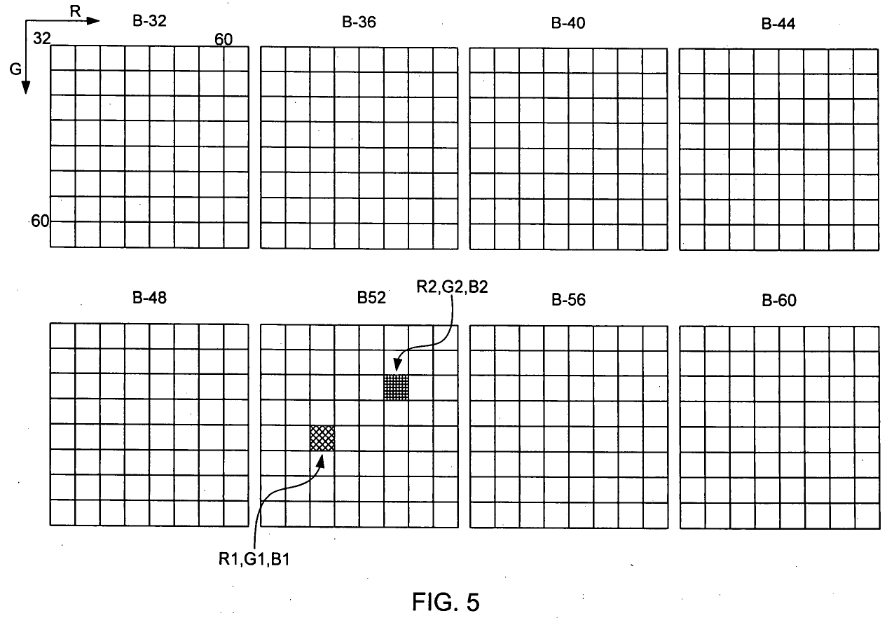

The color sample pattern generating circuit 212 generates a color sample pattern based on the sub-cube selected by the lattice retrieving part 208. The color sample pattern is essentially a breakdown of the selected sub-cube into a series of two-dimensional grids. FIG. 5 shows an example of a color sample pattern. As shown in FIG. 5, there are eight two dimensional grids, each grid corresponding to a particular blue B value, i.e., 32, 36, . . . , 60. Each grid represents red R values on the X-axis and green G values on the Y-axis. R1,G1,B1 corresponds to the RGB value designated by the user, which in this case corresponds to (40,48,52). R2,G2,B2 corresponds to a desired color, as will be explained in greater detail herein. In this case, R2,G2,B2 corresponds to (52,40,52). The color sample pattern generating circuit 212 provides the color sample pattern to the RGB-CMYK color converting part 216.

The color space of FIG. 4 and the color sample pattern of FIG. 5 each have a resolution of three bits. Accordingly, a particular box in the grid of the color sample pattern has a resolution of six bits. Limiting the resolution to three bits each has been done for ease of explanation and graphical representation. It should be understood that other resolutions, such as eight-bit, could be used. For example, the sub-cubes of the color space could be 16×16×16, and correspondingly the color sample pattern could include sixteen grids, with each grid being 16×16. Alternative configurations could be used for the color space and the color sample pattern to similarly obtain eight-bit or other resolutions, as would be understood by one skilled in the art (e.g., color space that is 32×32×32, and a color sample pattern with eight grids of 8×8 each).

The RGB signal converting unit 214 receives image data from the page memory 204. The RGB signal converting unit 214 is configured to convert one or more particular RGB values of the received image data to a desired value or color, as will be explained in greater detail herein. The RGB signal converting unit 214 provides the converted image data to the RGB-CMYK color converting unit 216.

The RGB-CMYK color converting unit 216 converts the image data (or the color sample pattern) from RGB data to CMYK data. The general conversion from RGB data to CMYK data is well known to one skilled in the art. The RGB-CMYK color converting unit 216 then provides the CMYK data to the image processing unit 218. The image processing unit 218 is configured to perform one or more image processing functions, such as filtering, smoothing, dithering, halftone processing, error diffusion, gamma correction, or shading compensation. The image processing unit 218 provides the processed CMYK data to the printer 220, which reproduces the original image scanned by the scanner 202 or the color sample pattern generated by the color sample pattern generating circuit 212.

FIG. 6 is a flow diagram of a color adjustment process consistent with the present invention. As shown in FIG. 6, a user first selects a color from a template (step 602). The template can be displayed to a user through the user interface 206, such as on a display panel on the image forming apparatus or a video screen or tablet connected to the image forming apparatus. The template provides an array of colors across the spectrum. To select a color, the user may use a touch screen, a pen, or a pointing device, such as a mouse. The color selected by the user preferably corresponds to a designated color that the user wants to be able to reproduce. The designated color selected from the template corresponds to a particular RGB value (R1,G1,B1).

Based on the RGB value corresponding to the designated color, a cube (or sub-cube) is identified from the color space (step 604). The sub-cube is selected by the lattice point retrieving unit 208 from the color space generated by the color space generating unit 210. As shown in FIG. 4, the color space includes a plurality of sub-cubes arranged in an 8×8×8 pattern to form an overall cubic color space. The sub-cube that is selected is the one that includes the RGB value within the range of RGB values included in the sub-cube. For example, if the designated RGB value is (40,48,52), then the sub-cube chosen is the one representing RGB values between (32,32,32) and (64,64,64).

A color sample pattern is generated for the selected sub-cube (step 606). More particularly, the color sample pattern generating circuit 212 generates the color sample pattern based on the sub-cube selected by the lattice point retrieving unit. FIG. 5 shows the example of a color sample pattern. As shown in FIG. 5, the color designated by the user, R1,G1,B1, corresponds to one of the boxes in one of the grids of the color sample pattern.

The color sample pattern, which is represented as RGB data, is converted to CMYK data (step 608). More particularly, the RGB-CMYK color converting unit 216 converts the color sample pattern from RGB data to CMYK data. The CMYK data of the color sample pattern is subjected to image processing by the image processing unit 218 (step 608). The image processing unit 218 provides the processed CMYK data of the color sample pattern to the printer 220, which prints the color sample pattern (step 610).

The user analyzes the printed color sample pattern and identifies a desired color from the printout (step 612). Due to issues related to resolution and conversion between RGB and CMYK data, as well as the limited number of inks used to form all colors, the designated color may be different from the desired color. In other words, the color selected by the user from the template, when reproduced by the printer, may be different than the printed color due to the resolution, the conversion process, and the limited number of inks. The user uses the printed color sample pattern to identify the color that most closely matches the desired color. For example, as shown in FIG. 5, R1,G1,B1 corresponds to the designated color selected from the template by the user, and R2,G2,B2 corresponds to the desired color for reproduction.

As also shown in FIG. 5, each box in each grid has a corresponding RGB value. For example, R1,G1,B1 corresponds to (40,48,52), and R2,G2,B2 corresponds to (52,40,52). Once the user identifies the desired color, the user enters the RGB data for that desired color (step 616). To enter the RGB data for the desired color, the user can use the user interface 206, which can have a keypad or touch screen that enables the user to enter the information.

The entered data is stored in the image forming apparatus to be used for selected RGB conversion (step 618). In particular, the RGB data of the desired color is stored in the RGB signal converting unit 214. The RGB data of the desired color (i.e., R2,G2,B2) is also linked to the RGB data of the color designated in the template (i.e., R1,G1,B1). The link enables the RGB signal converting unit 214 to convert RGB data having values corresponding to R1,G1,B1 to be converted to R2,G2,B2. The user does not have to enter the data for the color designated in the template as the color adjustment system already knows the value from the time the designation was made. At the time of designation, the RGB data of the designated color can be stored in the RGB signal converting unit 214, which is linked to the RGB data of the desired color when it is entered by the user. Once the link is made, the user can make copies of original images having the desired color.

When the copy is made, the scanner 202 scans the original image having the desired color (step 620). The scanner 202 generates RGB data from the scan of the original image. The RGB data of the original image is transferred from the scanner 202 to the page memory 204, which then-transfers the RGB data of the original image to the RGB signal converting unit 214.

The RGB signal converting unit 214 identifies the RGB data of the original image that corresponds to the color designated from the template (i.e., R1,G1,B1) (step 622). As described above, the RGB signal converting unit 214, after the user designates the color from the template of the user interface 206, stores the RGB values for the designated color. In addition, after entering the RGB data of the desired color selected from the color sample pattern, the RGB signal converting unit 214 links RGB values of the designated color R1,G1,B1 to the desired color R2,G2,B2. It should be understood that the identification can be performed for more than one designated color. In other words, the user may desire to have more than one color adjusted by the color adjusting process. To do so, the user can repeat steps 602 to 618 for each color the user desires to be adjusted.

For each pixel of the original identified as having RGB values corresponding to R1,G1,B1, the RGB signal converting unit 214 converts the identified pixel from R1,G1,B1 to R2,G2,B2 (step 624). For example, with reference to FIG. 5, each pixel of the original image having an RGB value of (40,48,52) is converted to (52,40,52). The RGB signal converting unit 214 provides the converted image data of the original image to the RGB-CMYK color converting unit 216, which converts the RGB data to CMYK data (step 626). The resulting CMYK data is provided to the image processing unit 218, which performs one or more image processing functions on the data (step 628). After performing the image processing, the original image is printed by the printer (step 630).

In accordance with the present invention, it is possible to reproduce a desired color that more closely matches the color of an original image. In particular, due to limitations from the resolution, the conversion of image data, and the inks used for reproduction when copying an original image, the color of the copy may not match the color of the original. In the color adjustment process, a color sample pattern is generated with colors that are very close to a color designated from a template, the designated color corresponding to the color the user wishes to reproduce precisely. The user selects the desired color from the color sample pattern and enters the value for selection. When the user makes a copy of a document having the desired color, any pixel having an RGB value corresponding to the value of the color designated from the template is converted to the value of the desired color selected from the color sample pattern. This conversion efficiently accounts for the differences between the color in the original image and the color reproduced without any conversion. As a result of the conversion, the user is able to produce copies with colors that closely match the original image.

The foregoing description of a preferred embodiment of the invention has been presented for purposes of illustration and description. It is not intended to be exhaustive or to limit the invention-to-the-precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method of reproducing a color copy of an original color image comprising:
receiving an indication of a selected color having a first RGB value from a plurality of colors;
generating a color sample pattern including the selected color having the first RGB value, the color sample pattern including colors with RGB values adjacent to the first RGB value;
receiving an indication of another selected color having a second RGB value corresponding to a color selected from the color sample pattern;
scanning an original image, the scanned original image comprising a plurality of pixels, each pixel having a corresponding RGB value;
identifying pixels of the scanned original image whose RGB value matches the first RGB value;
converting the RGB value of the identified pixels in the scanned original image to the second RGB value; and
reproducing-the-original-image-based-on-the-scanned original image and the converted pixels.

2. A method according to claim 1, further comprising printing the color sample pattern before receiving the indication of another selected color.

3. A method according to claim 1, further comprising:
generating a color space comprising a plurality of sub-groups, each sub-group representing a distinct portion of RGB values; and
identifying a sub-group, of the plurality of sub-groups, that includes the first RGB value,
wherein the color sample pattern is based on the identified sub-group.

4. A method according to claim 3, wherein each of the sub-groups is a sub-cube.

5. A method according to claim 4, wherein each sub-cube is either 8×8×8 or 9×9×9.

6. A method according to claim 1, wherein the first RGB value and the second RGB value are different.

7. A method according to claim 1, further comprising:
receiving an indication of another selected color having a third RGB value from a plurality of colors;
generating a second color sample pattern including the selected color with the third RGB value, the second color sample pattern including colors having RGB values adjacent to the third RGB value;
receiving an indication of another selected color having a fourth RGB value corresponding to a color selected from the second color sample pattern;
identifying pixels of the scanned original image whose RGB value matches the third RGB value; and
converting the RGB value of the identified pixels in the scanned original image to the fourth RGB value.

8. A method according to claim 1, wherein the color sample pattern comprises a plurality of color grids, each grid having a first one of R, G, and B values on a first axis and a second one of R, G, and B values on a second axis, and each grid corresponding to a third one of R, G, and B values.

9. A method according to claim 1, further comprising:
converting the scanned original image and the converted pixels from RGB data to CMYK data; and
performing at least one image processing function on the CMYK data,
wherein the reproduction of the original image is based on the CMYK data subjected to the at least one image processing function.

10. A method according to claim 9, wherein the at least one image processing function includes filtering, smoothing, dithering, halftone processing, error diffusion, gamma correction, or shading compensation.

11. A method of reproducing a color copy of an original color image comprising:
receiving an indication of a selected color having a first RGB value from a plurality of colors;
printing a color sample pattern including the selected color having the first RGB value, the color sample pattern including colors with RGB values adjacent to the first RGB value;
scanning an original image, the scanned original image comprising a plurality of pixels, each pixel having a corresponding RGB value;
converting pixels in the scanned original image from the first RGB value to a second RGB value identified from the color sample pattern; and
reproducing the original image based on the scanned original image and the converted pixels.

12. An image forming apparatus for reproducing a color copy of an original color image comprising:
a user interface configured to receive an indication of a selected color having a first RGB value from a plurality of colors;
a color sample pattern generating circuit configured to generate a color sample pattern including the selected color having the first RGB value, the color sample pattern including colors with RGB values adjacent to the first RGB value;
a scanner that scans an original image, the scanned original image comprising a plurality of pixels, each pixel having a corresponding RGB value;
an RGB signal converting unit configured to identify pixels of the scanned original image whose RGB value matches the first RGB value and to convert the RGB value of the identified pixels in the scanned original image to a second RGB value; and
a printer that reproduces the original image based on the scanned original image and the converted pixels,
wherein the user interface is further configured to receive an indication of another selected color having the second RGB value corresponding to a color selected from the color sample pattern.

13. An image forming apparatus according to claim 12, wherein the printer prints the color sample pattern before receiving the indication of another selected color.

14. An image forming apparatus according to claim 12, further comprising:
a color space generating circuit configured to generate a color space comprising a plurality of sub-groups, each sub-group representing a distinct portion of RGB values; and
a lattice point retrieving unit configured to identify a sub-group, of the plurality of sub-groups, that includes the first RGB value,
wherein the color sample pattern is based on the identified sub-group.

15. An image forming apparatus according to claim 14, wherein each of the sub-groups is a sub-cube.

16. An image forming apparatus according to claim 15, wherein each sub-cube is either 8×8×8 or 9×9×9.

17. An image forming apparatus according to claim 12, wherein the first RGB value and the second RGB value are different.

18. An image forming apparatus according to claim 12, wherein the user interface is further configured to receive an indication of another selected color having a third RGB value from a plurality of colors,
wherein the color sample pattern generating circuit is further configured to generate a second color sample pattern including the selected color with the third RGB value, the second color sample pattern including colors having RGB values adjacent to the third RGB value;
wherein the user interface is further configured to receive an indication of another selected color having a fourth RGB value corresponding to a color selected from the second color sample pattern; and
wherein the RGB signal converting unit is further configured to identify pixels of the scanned original image whose RGB value matches the third RGB value and to convert the RGB value of the identified pixels in the scanned original image to the fourth RGB value.

19. An image forming apparatus according to claim 12, wherein the color sample pattern comprises a plurality of color grids, each grid having a first one of R, G, and B values on a first axis and a second one of R, G, and B values on a second axis, and each grid corresponding to a third one of R, G, and B values.

20. An image forming apparatus according to claim 12, further comprising:
a color converting unit configured to convert the scanned original image and the converted pixels from RGB data to CMYK data; and
an image processing unit configured to perform at least one image processing function on the CMYK data,
wherein the reproduction of the original image is based on the CMYK data subjected to the at least one image processing function.

21. An image forming apparatus according to claim 20, wherein the at least one image processing function includes filtering, smoothing, dithering, halftone processing, error diffusion, gamma correction, or shading compensation.
